(19) United States
(12) Patent Application Publication
(10) Pub. No.: US 2023/0319538 A1
(43) Pub. Date: Oct. 5, 2023

(54) Public Warning Messages for Emergency Services on Xn/X2 Interface

(71) Applicant: Parallel Wireless, Inc., Nashua, NH (US)

(72) Inventors: Pankaj Bunde, Pune (IN); Praveen Jain, Pune (IN); Lakhan Sharma, Pune (IN)

(21) Appl. No.: 18/295,262

(22) Filed: Apr. 3, 2023

Related U.S. Application Data
(60) Provisional application No. 63/326,411, filed on Apr. 1, 2022.

(51) Int. Cl. H04W 4/90; H04W 4/12

(52) U.S. Cl. CPC H04W 4/90; H04W 4/12

(57) ABSTRACT

This invention provides warning messages for emergency services in a wireless network. In one embodiment, a method of providing public messages for emergency services includes sending, by a Core Access and Mobility Management Function (AMF), a warning message to a first node over a first interface; broadcasting, by the first node, the warning message to all User Equipments (UEs) in the area; sending, by the first node, a warning response message to the AMF; sending, by the first node, the warning message to at least one other node connected over a second interface to the first node; and broadcasting, by the at least one other node, the warning message to all UEs in their respective area and sending a warning message response back to the first node over the second interface.

### CROSS-REFERENCE TO RELATED APPLICATIONS

The present application claims priority under 35 U.S.C. § 119(e) to U.S. Provisional Patent Application No. 63/326,411, filed Apr. 1, 2022 and having the same title as the present application, which is hereby incorporated by reference in its entirety for all purposes. The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. patent application Ser. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

Public Warning System helps protect lives and property by enabling governments to provide timely alerts to at-risk citizens when natural disasters, public health threats and human-induced emergencies arise.

Public warning systems should alert and inform all citizens that are threatened by a hazard with the final purpose of enabling them to prepare and to act in a timely manner to reduce the impact of the hazard.

During emergency situation, it is very important to reach the maximum number of people in the impacted area and to the people in adjoining areas who may get into this risk, in very less time or before emergency situation happens in that area to lessen the severity. So sending warning message in the affected area along with neighboring area is always better in emergency situation.

3GPP Public Warning Systems (PWS) were first specified in Release 8, allowing for direct warnings to be sent to mobile users. The PWS is used to alert the public to events such as disasters. For instance, when earthquakes, tsunamis, hurricanes, or wildfires occur, the PWS can be used to notify people to evacuate impacted areas within a certain time. In addition, the PWS can be used to notify people of a Child Abduction Emergency (e.g., AMBER alert). PWS notifications should be delivered accurately and in a timely manner to the public in order to help people prepare sufficiently for events.

### SUMMARY

This invention provides warning messages for emergency services in a wireless network. In one embodiment, a method of providing public messages for emergency services includes sending, by a Core Access and Mobility Management Function (AMF), a warning message to a first node over a first interface; broadcasting, by the first node, the warning message to all User Equipments (UEs) in the area; sending, by the first node, a warning response message to the AMF; sending, by the first node, the warning message to at least one other node connected over a second interface to the first node; and broadcasting, by the at least one other node, the warning message to all UEs in their respective area and sending a warning message response back to the first node over the second interface.

### BRIEF DESCRIPTION OF THE DRAWINGS

FIG. 1 depicts a schematic diagram of a broadcast warning message system in a 5G network.

FIG. 2 depicts a schematic diagram of a broadcast warning message system in a 5G network with an affected area area and a neighbor area, in accordance with some embodiments.

FIG. 3 depicts a schematic diagram of a broadcast warning message system in a 5G network with an X2 write-replace request, in accordance with some embodiments.

FIG. 4 is a call sequence diagram of a broadcast warning message system in a 5G network, in accordance with some embodiments.

FIG. 5 is a schematic network architecture diagram for 3G and other-G prior art networks, in accordance with some embodiments.

FIG. 6 is an enhanced gNodeB for performing the methods described herein, in accordance with some embodiments.

FIG. 7 is a coordinating server for providing services and performing methods as described herein, in accordance with some embodiments.

### DETAILED DESCRIPTION

Public Warning System (PWS) support in the 5G architecture relies on the usage of the concept called Cell Broadcasting—the ability to trigger the radio network to transmit one single short message to multiple devices in the network simultaneously. Messages are broadcast either within the whole network or within certain geographical areas, down to the size of a single radio cell. This is controlled from the network on request from the originator of the message.

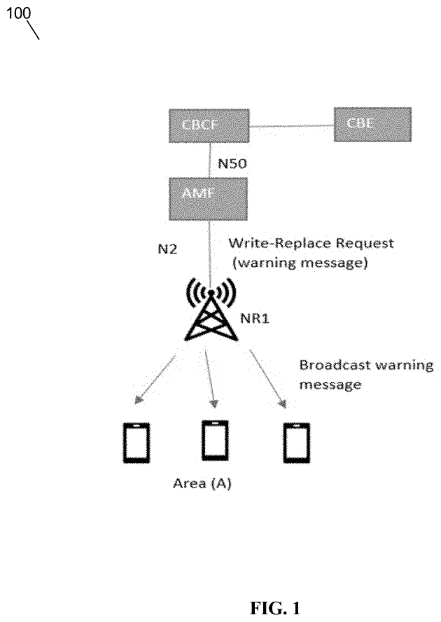

FIG. 1 depicts a schematic diagram of a broadcast warning message system in a 5G network. FIG. 1 shows the architecture when 5G Core and the new 5G Radio is used. Upon a request from the cell broadcast entity (CBE), which is not under 3GPP spec, the cell broadcast center function (CBCF)/PWS initiates the Write-Replace Warning procedure. (The CBCF is responsible for all kinds of broadcast messages in the network, and provides content, message ID, number of times to broadcast, interval for broadcast, whether the message is canceled, etc.) This initiation is performed by sending a Write-Replace Warning Request message to the AMF over N50 interface. The AMF initiates the procedure by sending a WRITE-REPLACE WARNING REQUEST message to the NG-RAN node. Upon receipt of the WRITE-REPLACE WARNING REQUEST message, the NG-RAN node shall prioritize its resources to process the warning message. The Write Replace Warning Procedures cause either a Cell ID List, Tracking Area List, or Emergency Area List generated with a list of areas together with the warning contents included in the message. The NR upon receipt of Write Replace request from the AMF, floods these Write Replace Warning messages in the specified tracking area, emergency area or cells, with the warning message. At any point of time CBCF/PWS can cancel a broadcast by specifying the message ID that is currently actively broadcasted.

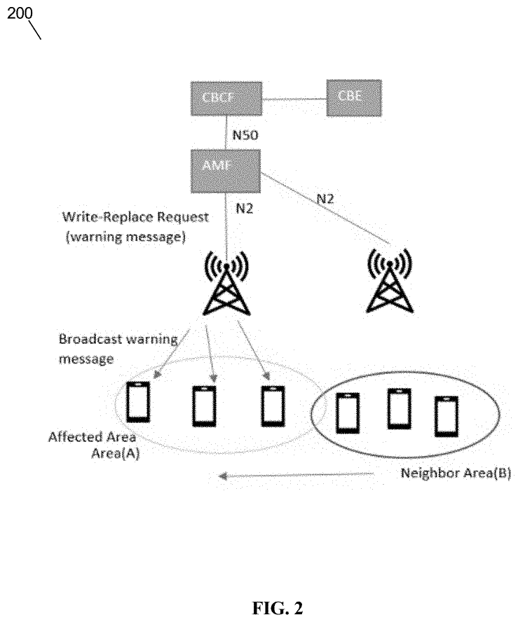

FIG. 2 depicts a schematic diagram of a broadcast warning message system in a 5G network with an affected area area and a neighbor area, in accordance with some embodiments.

In the case that some emergency situation happens (natural disaster or some criminal activity or road traffic condition) in Area (A) which is served by Ng-RAN1, the AMF sends Warning (Write-Replace Request) message to Ng-RAN1, and then the Ng-RAN1 broadcasts this warning alert message to all UEs in Area (A). People in Area (A) get alerted and take necessary action.

But People in neighboring Area (B) served by Ng-RAN2 are not aware of this emergency and there are high possibilities of people traveling from Area (B) to Area (A). Those people might get affected and casualties can increase. As shown in FIG. 2 and following, we can lessen the overall impact by sending warning messages to adjoining area in advance. So People being notified can refrain from getting into impacted Area (A).

In a typical 5G deployment network, gNBs communicate with each other over Xn interface for Mobility and Load Balancing purposes. Through our solution we are trying to leverage this Xn interface for Public Warning Purposes.

AMF is not aware of the gNBs neighbor associations and resultant topology. It will send Warning message only to the gNBs as specified in Write-Replace request message. With our solution we can use Xn interface to send warning messages to the adjoining gNBs.

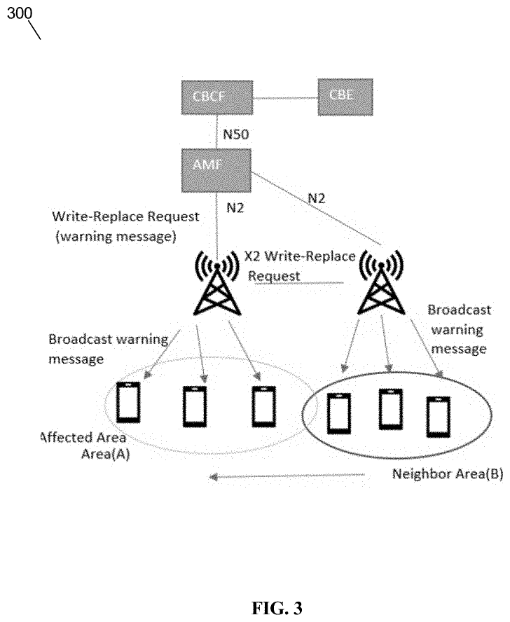

FIG. 3 depicts a schematic diagram of a broadcast warning message system in a 5G network with an X2 write-replace request, in accordance with some embodiments. Referring to FIG. 3, once gNB receives warning messages over Xn interface, it can broadcast these messages to all UEs in that area. The users looking at the content of this warning message will be apprised about the emergency situation and take necessary steps.

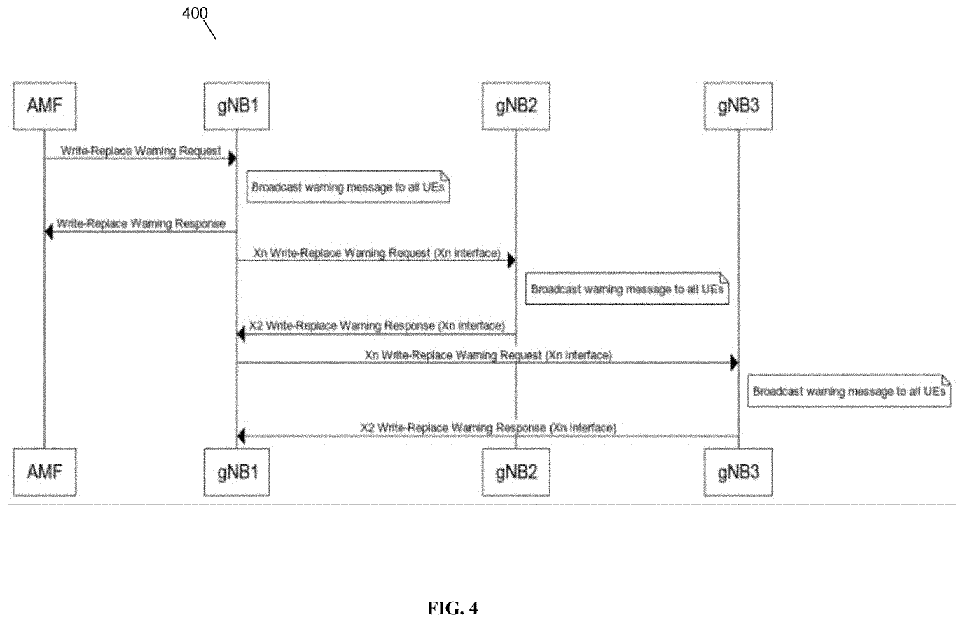

As part of this solution, we are proposing to forward Write-Replace request message received from AMF to the neighboring gNBs over Xn interface. Detailed call flow is explained below in FIG. 4. This solution is applicable for standalone 4G as well as NSA deployments over X2 interface.

FIG. 4 is a call sequence diagram of a broadcast warning message system in a 5G network, in accordance with some embodiments.

AMF sends Write-Replace Request message to gNB1 over N2 interface

gNB1 broadcasts this Write-Replace request message to all UEs in thar area

gNB1 sends Write-Replace Response message to AMF

gNB1 sends Write-Replace request message to all gNBs (gNB2 and gNB3) connected over Xn interface.

gNB2 and gNB3 broadcast that Warning message to all UEs in their respective area and send Response back to gNB1 over Xn interface.

In some embodiments, the set of Xx/Xn/X2 neighbors is found in the automatic neighbor relation (ANR) list of cell gNB1, which knows what other cells are nearby; the establishment of neighbor relations between cells is well-understood in the art. Cell gNB1 thus initiates sending to its established neighbors. Cells gNB2 and gNB3, as well as any other cells, are configured to receive a message from gNB1 with Write-Replace-Request messages with broadcast warning messages, and when received, they broadcast the messages.

In some embodiments, this method may be used for non-emergency messages, broadcast and non-broadcast messages, or any other messages that are sent and received using the CBE/CBCF/PWS architecture.

In some embodiments, messages that are requested to be sent by neighbor cells can be marked with the originating cell. This may be useful if there are emergency events taking place in the area of cell gNB1, and it is desirable for users to avoid entering into the area of cell gNB1, which can be effectuated using a message stating that there is an emergency situation happening there.

In some embodiments, messages may be human-readable; in other embodiments, messages may be transmitted in an encoded fashion and decoded by using a list of predetermined messages prior to being displayed to the user. In some embodiments, the network operator may assign specific messages or predetermined messages.

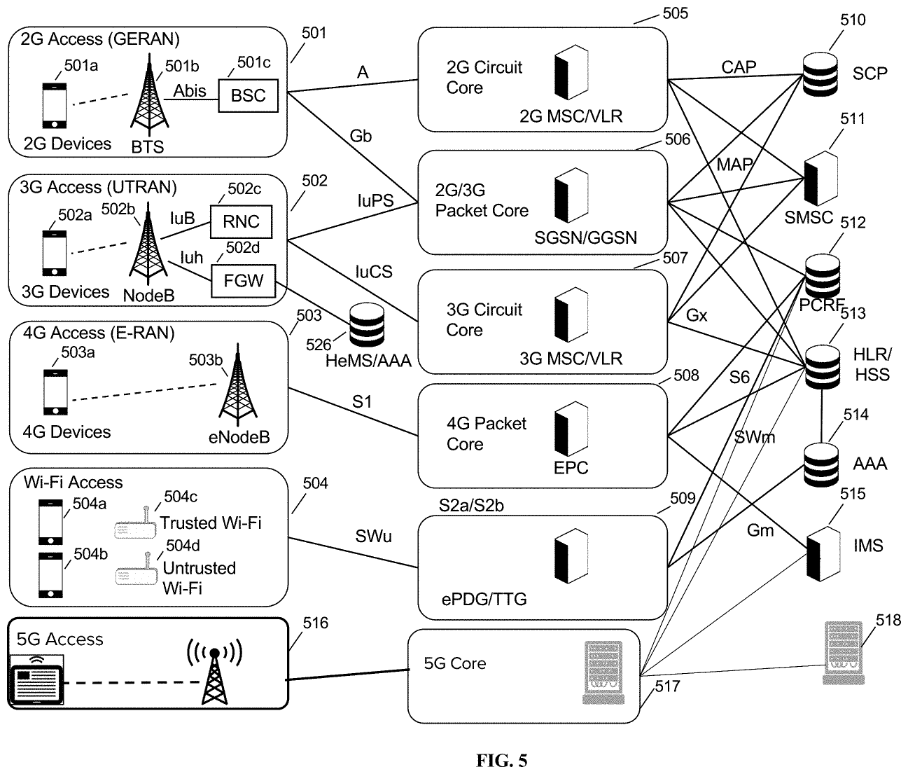

FIG. 5 is a schematic network architecture diagram for 3G and other-G prior art networks, in accordance with some embodiments. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

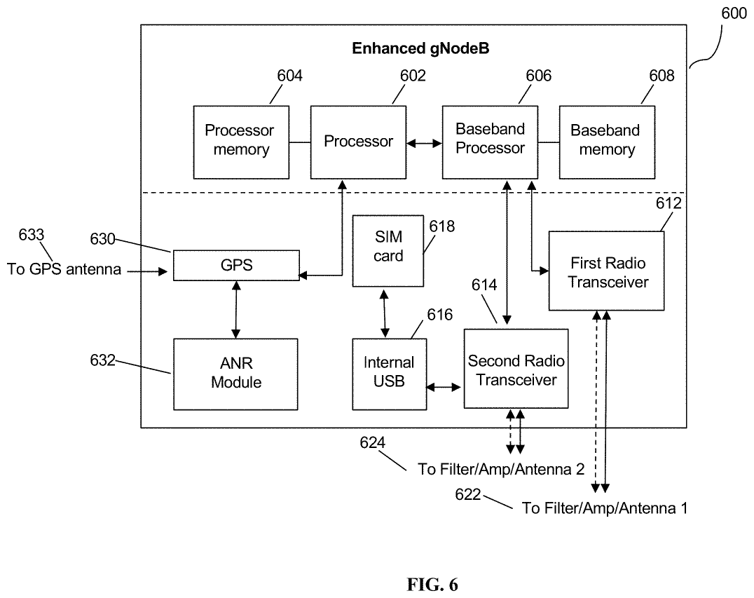

FIG. 6 is an enhanced gNodeB for performing the methods described herein, in accordance with some embodiments. eNodeB 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

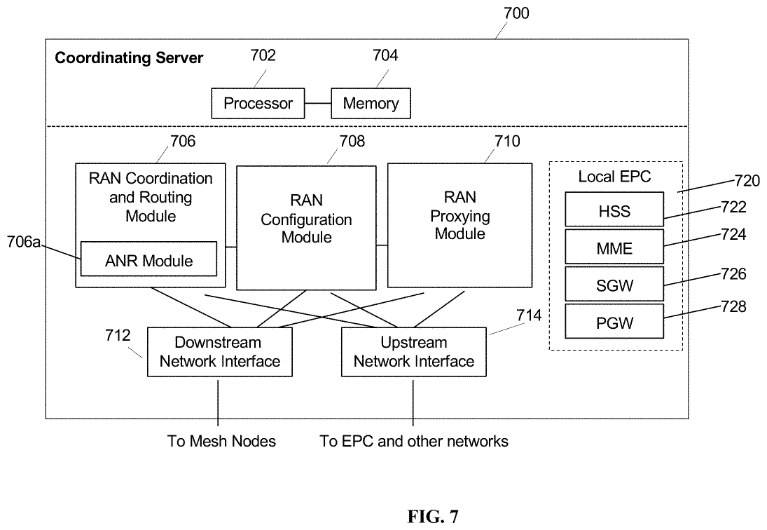

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the 3GPP 5G standard, one of skill in the art would understand that these systems and methods could be adapted for use with other wireless standards or versions thereof. The inventors have understood and appreciated that the present disclosure could be used in conjunction with various network architectures and technologies. Wherever a 5G technology is described, the inventors have understood that other RATs have similar equivalents, such as an LTE for 4G equivalent of gNB, and particularly, X2 in place of Xn or Xx. Wherever an AMF is described, the AMF could be a 3G RNC or a 4G MME. Additionally, wherever an AMF is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing public messages for emergency services, comprising:
sending, by an Core Access and Mobility Management Function (AMF), a warning message to a first node over a first interface;
broadcasting, by the first node, the warning message to all User Equipments (UEs) in the area;
sending, by the first node, a warning response message to the AMF;
sending, by the first node, the warning message to at least one other node connected over a second interface to the first node; and
broadcasting, by the at least one other node, the warning message to all UEs in their respective area and sending a warning message response back to the first node over the second interface.
